(19) United States
(12) Patent Application Publication
(10) Pub. No.: US 2004/0076574 A1
(43) Pub. Date: Apr. 22, 2004

(54) Surface-modified Ca(CO3) and polymers containing same

(76) Inventors: Peter W.Q. Xu, Northboro, MA (US); Robert J. Nehring JR., Hopedale, MA (US)

Correspondence Address: Alvin Isaacs, Esq., 9544 Hawksmoor Lane, Sarasota, FL, 34238-3221, US

(21) Appl. No.: 10/662,238

(22) Filed: Sep. 16, 2003

Related U.S. Application Data
(63) Continuation of application No. 09/676,658, filed on Oct. 2, 2000.

(51) Int. Cl. C01F 11/18

(52) U.S. Cl. 423/430

(57) ABSTRACT

A method for preparing a surface-modified calcium carbonate useful in the synthesis of polyesters such as polyethylene terephthalate, polybutylene terephthalate, etc. to improve the polymer's friction coefficient, which method comprises the step of forming a dispersion calcium carbonate particles and a monomeric bi-functional reagent having two functional linking substituents consisting of (1) a first substituent linking to the calcium carbonate particles and (2) a second substituent which can link to the polyester, thereby bonding the calcium carbonate to the polyester through the monomeric bi-functional linking reagent; and surface-modified calcium carbonate containing same.

### RELATED APPLICATION

This application is a continuation of Ser. No. 09/676,658 filed Oct. 2, 2000; and

### BACKGROUND OF THE INVENTION

It is per se known in the art to employ calcium carbonate in the synthesis of polyesters such as polyethylene terephthalate (PET) , polybutylene terephthalate (PBT), etc. used in making films or fibers, in order to improve the polymer's friction coefficient. Since the present invention is particularly directed to the manufacture of PET, for purposes of illustration it will be discussed hereinafter with reference thereto.

U.S. Pat. No. 5,000,871 issued to Shiro Minayoshi et al. is thought by Applicant to be the prior art most relevant to the present invention.

As mentioned under the BACKGROUND OF THE INVENTION in this patent, although the physical and chemical properties of calcium carbonate make it particularly useful in the manufacture of fibers, films and various moldings, it is however known to have a shortcoming in sliding property during the molding process as well as other problems which are all mostly attributable to the high coefficient of friction of the polyester itself. Accordingly, to overcome these problems, many methods have previously been suggested, which methods essentially consist of incorporating in the PET fine particles in order to impart a proper degree of roughness to the molded article and thereby improve the surface-sliding property of the molded article. However, it was found that the affinity between these fine particles and the PET was insufficient, so that there was invariably something left to be desired about the transparency and wear-resistance of the films, fibers and the like made by such references.

Among these means for improving the PET surface properties which are known in the art, mention may be made of the following:

(1) method of separating out at least part of the catalyst, etc. used in the PET synthesis (referred to in the aforementioned U.S. Pat. No. 5,000,871 as the “internal particle separating-out method”) and

(2) method of adding fine particles of an inorganic compound insoluble in and inert to the PET during or after polymerization, e.g. titanium dioxide, silica (silicon dioxide), talc, kaolin, and calcium carbonate (termed by the patentee as the “external particle adding method.”

The former method (1) is said by the patentee to suffer from the difficulty of controlling the amount and size of the particles and in preventing the formation of coarse particles; while the latter method (2), while superior to the former method (1) with regard to the sliding property, possesses insufficient affinity with the PET, permitting separation at the interface between the particles and the PET during stretching of the polymer, etc., which, in turn causes problems in transparency and wear resistance which, according to the patentee, have yet to be solved. These and other proposed methods for preparing the polyesters are disclosed in Columns 1 and 2 of the patent and need not be further discussed here.

The primary objects of the patented invention are said to be to provide a glycol dispersion of calcium carbonate having a good dispersion stability and a good affinity with the polyester, the calcium carbonate being uniform in particle size distribution and having its particle size freely selectable.

These objects are said to be obtained by a glycol dispersion of calcium carbonate prepared by the process of wet grinding a glycol slurry composed of glycol and calcium carbonate whose surface has been treated with a copolymer (A) of at least one of an α,β-monoethylenically unsaturated carboxylic acid or its salts with an α,β-monoethylenically unsaturated carboxylic acid ester and/or a salt(B) of a copolymer of an α,β-monoethylenically unsaturated carboxylic acid with an α,β-monoethylenically unsaturated carboxylic acid ester.

The present invention has for its task to provide improvements over the teachings of U.S. Pat. No. 5,000,871 discussed, supra in surface modification of calcium carbonate for use in the synthesis of polyesters contemplated for the manufacture of fibers, films, molded articles and the like, which improvements will be discussed in detail hereinafter.

### BRIEF DESCRIPTION OF THE INVENTION

In accordance with the present invention, the stated task is solved in an elegant manner utilizing more cost-effective and commercially available materials which obviate all of the problems heretofore discussed, in which the surface of the calcium carbonate dispersant in glycol is modified by bonding to the surface of the calcium carbonate a monomeric bi-functional reagent having first and second functional substituents, the first functional substituent being reactable to bond the monomeric bi-functional reagent to the surface of the calcium carbonate; while the second of the two bi-functional substituents is adaptable for reaction with polymers such as polyesters, exemplified by PET and PBT, to couple the polymer to the monomeric bi-functional reagent now having the calcium carbonate bonded to it through the first-mentioned functional substituent.

### DETAILED DESCRIPTION OF THE INVENTION

Stated simply, the present invention in its broadest terms resides in linking calcium carbonate to a polyester through a monomeric reagent having two functional linking substituents, the calcium carbonate first being bonded to the reagent through one of the two functional substituents at an initial step in the synthesis; and at a later stage in the synthesis the polyester is then bonded to the second of the two functional linking substituents.

In its broadest terms, the instant invention contemplates use of any innocuous monomeric reagent containing two linking substituents which will accomplish the desired linking of the calcium carbonate to the polyester.

However, in the present state of the R&D project, it is to be expressly understood that to date only acid groups, e.g. carboxy (—COOH) or phosphono ((HO)₂PO—) substituents for linking the calcium carbonate to the reagent; and hydroxyl substituents for linking the polyester to the reagent have actually been employed.

As examples of useful bi-functional reagents of this description, mention may be made of the following:

gluconic acid ( (CH₂(OH)CH(OH)CH(OH)CH(OH)CH(OH)COOH),

malic acid (HOOC—CH2—CH(OH)—COOH) ),

tartaric acid (HOOC—CH(OH)—CH(OH)—COOH),

phenylphosphonic acid (C₆H₅O—P—(OH)₂

methanephosphonic acid (CH₃PO(OH)₂, etc. .

Preferably, the calcium carbonate particles have a mean particle size no greater than about 2.50 microns. However, in one application of the invention, the calcium carbonate particles should have a mean particle size no greater than about 0.40 micron. They may initially possess that particle size distribution; or, optionally, as seen in the appended illustrative examples, the particle size to achieve this distribution may be obtained in situ by milling the calcium carbonate particles simultaneously with the surface modification in which the monomeric bi-functional reagent is chemically bonded to the surface of the calcium carbonate particles.

The following examples illustrate by example and not by limitation the practice of this invention:

### EXAMPLE 1

188.5 gms. of ethylene glycol were added into an attritor mill containing 660.0 gms. of A050 glass beads. 4.7 gms of the bi-functional reagent, gluconic acid were then added to the ethylene glycol. 16.8 gms of a polyacrylate dispersant, Colloid 286N with 50% activity (from Vinning Industries) were then added. Finally, 140 gms. of Albafil DP6095 (precipitated calcium carbonate from Specialty Mills) were introduced into the mill. The calcium carbonate was then simultaneously surface treated and ground. After about 15 minutes, the mean particle size of the calcium carbonate had been reduced from about 0.92μ to about 0.5μ. 30, 45, 60, and 150 minutes of further grinding produced the surface-treated calcium carbonate with medium particle sizes of 0.42, 0.39, 0.36 and 0.33μ, respectively. The resulting surface-treated calcium carbonate of this Example may then be directly used in conventional manner in polyester synthesis. [If the water content of the slurry is found to be too high, it can first be subjected to a dewatering step.]

### EXAMPLE 2

Example 1 was repeated, substituting 177.8 gms. of ethylene glycol; 157.5 gms. of Albafil; 5.25 gms of gluconic acid; and 9.45 gms. of Colloid 286N for the amounts of the respective ingredients in Example 1. Milling for 60 minutes reduced the mean particle size of the calcium carbonate from 1.25μ to 0.35μ; viscosity: 63.5 cps. Separation through a silk screen afforded 280 gms. of product.

### EXAMPLE 3

179.52 gms. of ethylene glycol were introduced into an attritor mill containing 660.0 gms. of A050 glass beads. 1.99 gms. of malic acid (99%) were then added, followed by 10..99 gms. of Colloid 21100 polyacrylate dispersant. Finally, 157.5 gms. of Albafil 6095 precipitated calcium carbonate. As in Example. 1, the Albafil was then simultaneously surface treated and ground. After milling for 60 minutes at 1600 RPM, the mean particle size was reduced from 1.26μ to 0.36μ; viscosity: 68 cps. The particles were separated through a silk screen to yield 281 gms. of product.

### EXAMPLE 4

181.06 gms. of ethylene glycol were introduced into an attritor mill containing 660.0 gms of glass beads. 1.99 gms of malic acid (99%) were then added, followed by 9.45 gms. of Colloid 286N and then 157.5 gms of the Albafil DP6095 calcium carbonate. After milling for 60 minutes at 1600 RPM, the mean particle size of the calcium carbonate was reduced from 1.24μ to 0.36μ; viscosity: 68 cps. Filtering through a silk screen yielded 283.5 gms. of product.

### EXAMPLE 5

In the manner of the previous examples, 660.0 gms. of glass beads, 1.97 gms. of tartaric acid, 9.45 gms. of Colloid 286N, and 157.5 gms. of Albafil DP6095 were added in an attritor mill to 181.08 gms. of ethylene glycol. After milling for about 60 minutes at 1600 RPM, the Albafil calcium carbonate particles were reduced in size from a mean particle size of 1.26μ to 0.33μ; viscosity 75 cps. The particles were separated through a silk screen to yield 278 gms. of product.

### EXAMPLE 6

Repeating Example 5 gave calcium carbonate particles having a mean particle size reduced from 1.24μ to 0.35μ. Separation through a silk screen yielded 293.5 gms of product.

As was mentioned previously, the present invention is particularly directed to improvements in the synthesis of polyesters contemplated for the manufacture of fibers, films and various moldings. The novel modified calcium carbonates of this invention may be utilized in the synthesis of polyesters in per se known manner for prior syntheses employing the addition of calcium carbonate in the polyester manufacture.

Accordingly, other than the substitution of the modified calcium carbonate of this invention, patentable novelty cannot be asserted in its usage in the polyester synthesis. In other words, the polyester synthesis will be within the expected judgment of the skilled worker.

In the following illustrative example of polyester synthesis, it is pointed out that since Applicant's employer, Nyacol Nano Technologies, Inc., the assignee of the present invention, does not have in its R&D facilities adequate equipment for such polymer syntheses, the Example has not yet been physically performed and is accordingly properly written in the present tense. The Example is derived from APPLICATION EXAMPLE 2 in the paragraph bridging Cols. 19-20 of the aforementioned U.S. Pat. No. 5,000,871.

### EXAMPLE 7

100 parts by weight (pbw) of dimethyl phthalate and 70 pbw of ethylene glycol are subjected to ester exchange reaction in a usual manner with 0.035 pbw of tetrahydrate of manganese acetate catalyst. To the resulting ethylene glycol dispersion a modified calcium carbonate dispersion of this invention (e.g., as prepared in any of the foregoing illustrative examples) can be added with stirring until the desired calcium carbonate concentration in the polymer is obtained, e.g. 5000 PPM. Then polycondensation may be performed in a usual manner in vacuo at an elevated temperature to form polyethylene terephthalate. The polyester may then be employed in film manufacture by melting, extruding and stretching a plurality of times both longitudinally and laterally. In the patent example, it is stretched 3.5 times longitudinally at 90° C. and 3.5 times laterally at 130° C.

When a slurry of the novel calcium carbonate dispersant of this invention is used in polyester polymerizations such as illustrated in the above example, the calcium carbonate will couple with the polymer, as previously explained, which coupling will increase the molecular weight of the final product and/or achieve a desired viscosity in a shorter time. The polyester so obtained will have better properties in the slideness during film orientation, as manifested by less separation of the polymer from the calcium carbonate due to the coupling of the calcium carbonate to the polyester, as previously explained.

In the foregoing description, including the illustrative examples, a calcium carbonate dispersion in ethylene glycol was utilized. However, the invention is not limited thereto. For example, other dispersants are also contemplated. Moreover, the calcium carbonate particles may be added “dry”, in which the dispersion is then formed in the bi-functional reagent, e.g. gluconic acid.

Since certain changes may be made without departing from the scope of the invention, it is intended that all matter disclosed in the foregoing description and in the illustrative examples be intended as being lillustrative and not in a limiting sense.

What is claimed is:

1. A method for preparing a surface-modified calcium carbonate comprising the step of:
forming a glycol dispersion comprising calcium carbonate particles and a monomeric bi-functional reagent having two functional linking substituents consisting of a first substituent which can link to the calcium carbonate particles and a second substituent which can link to a polyester, whereby the first substituent of the bi-functional reagent reacts to bond the bi-functional reagent to the calcium carbonate particles.

2. A method as defined in claim 1 wherein the first substituent comprises an acid group.

3. A method as defined in claim 1 wherein the first substituent comprises a carboxy or a phosphino radical.

4. A method for preparing a surface-modified calcium carbonate comprising the step of:
forming a glycol dispersion comprising calcium carbonate particles and a monomeric bi-functional reagent having two functional linking substituents consisting of a first substituent which can link to the calcium carbonate particles and a second substituent which can link to a polyester, whereby the first substituent of the bi-functional reagent reacts to bond the bi-functional reagent to the calcium carbonate particles, characterized in that the bi-functional reagent is selected from the group consisting of gluconic, malic and tartaric acids.

5. A method as defined in claim 1 wherein the dispersion is formed in ethylene glycol.

6. A method for preparing a surface-modified calcium carbonate comprising the steps of:
forming a dispersion in ethylene glycol of calcium carbonate particles and a monomeric bi-functional reagent having first and second linking substituents, the first linking substituent being an acid group which can react to chemically bond to calcium carbonate particles; and a second linking substituent being a hydroxyl group which can react to chemically bond to a polyester, whereby the bi-functional reagent in the dispersion is bonded to the surface of the calcium carbonate particles through the acid group.

7. A method as defined in claim 6 wherein the acid group comprises a carboxy radical.

8. A method for preparing a surface-modified calcium carbonate monomer comprising the steps of forming a dispersion in ethylene glycol of calcium carbonate particles and a monomeric bi-functional reagent having first and second linking substituents, the first linking substituent being an acid group which can react to chemically bond to the calcium carbonate particles; and the second linking substituent having a hydroxyl group which can react to chemically bond to q polyester, whereby the bi-functional reagent in the dispersion is bonded to the surface of the calcium carbonate particles through the acid group, characterized in that the bi-functional reagent is selected from the group consisting of gluconic, malic and tartaric acids.

9. A process as defined in claim 6 including the step of milling the calcium carbonate in the ethylene glycol to reduce the particle size of the calcium carbonate particles to a mean particle size no greater than about 2.50 microns.

10. A surface-modified calcium carbonate monomer prepared by the process defined in claim 6.

11. A surface-modified calcium carbonate monomer prepared by the process defined in claim 9.

12. A surface-modified calcium carbonate monomer comprising particles of calcium carbonate having a monomeric bi-functional reagent chemically bonded to their surface through one functional substituent of the bi-functional reagent, the other functional substituent of the bi-functional reagent being adapted for chemically bonding to polyester.

13. A surface-modified calcium carbonate as defined in claim 12 wherein the one functional substituent comprises an acid group.

14. A surface-modified calcium carbonate comprising particles of calcium carbonate having a monomeric bi-functional reagent chemically bonded to the surface of the particles through one functional substituent of the monomeric bi-functional reagent, the other functional substituent being for chemically bonding to polyester, whereby to bond the calcium carbonate particles to polyester through the bi-functional reagent, characterized in that the monomeric bi-functional reagent is selected from the group consisting of gluconic acid, malic acid and tartaric acid.

15. A surface-modified calcium carbonate monomer as defined in claim 14 wherein a polyester is bonded to the other substituent of the bi-functional reagent, thereby linking the calcium carbonate particles to the polyester through the bi-functional reagent.
